(19) United States
(12) Patent Application Publication
(10) Pub. No.: US 2010/0294258 A1
(43) Pub. Date: Nov. 25, 2010

(54) OVEN, CURTAIN DEVICE THEREOF, AND METHOD OF USING THE OVEN

(76) Inventor: Yong-Seog Jeon, Seoul (KR)

Correspondence Address: MCKENNA LONG & ALDRIDGE LLP, 1900 K STREET, NW, WASHINGTON, DC, 20006, US

(21) Appl. No.: 12/811,481

(22) PCT Filed: Sep. 8, 2008
(86) PCT No.: PCT/KR08/05301

§ 371 Date: Jul. 1, 2010

(30) Foreign Application Priority Data
Jan. 4, 2008 (KR) 10-2008-0001340

(51) Int. Cl. F24C 15/18; B23P 19/00

(52) U.S. Cl. 126/19 R; 29/426.2

(57) ABSTRACT

Provided is an oven including a cavity, a curtain, and a fixing portion. The cavity receives and heats a food. The curtain shields at least one sidewall of the cavity. The fixing portion fixes the curtain to the cavity. Thus, the oven is used under clean conditions, and the cooked conditions of the food are more sanitary and clean.

### TECHNICAL FIELD

The present disclosure relates to an oven, a curtain device thereof, and a method of using the oven.

### BACKGROUND ART

Ovens, which are cooking appliances, are used for heating a food disposed in their cavity.

Since such an oven heats a food in a closed space, food remainders splashed during cooking adhere to a sidewall of a cavity, and smoke generated from a burned food also adheres to the sidewall. The remainders and smoke become contaminants of the cavity, thereby causing a user much inconvenience. For example, decayed contaminants cause many problems including unsanitary conditions and stenches.

To address these problems, it has been typically required to periodically clean the cavity with a detergent, but this also causes a user much inconvenience.

Alternatively, pyrolysis has been suggested, which is a method of intentionally burning all contaminants adhered to an oven cavity by operating all heaters installed in the oven cavity with a maximum output. However, the pyrolysis method causes an oven cavity to have a high temperature, thus safety problems arise, and large electricity is consumed, and it takes a lot of time to clean the cavity.

### DISCLOSURE OF INVENTION

### Technical Problem

Embodiments provide an oven, a curtain device thereof, and a method of using the oven, which can inherently prevent a contaminant from adhering to an inner wall of an oven cavity, so that the oven can be used under more clean conditions.

Embodiments also provide an oven, a curtain device thereof, and a method of using the oven, which can absorb an undesirable material generated in an oven during cooking and prevent the undesirable material from adhering to a food, thereby improving cooked conditions of the food and the satisfaction of a user.

### Technical Solution

In one embodiment, an oven includes: a cavity receiving and heating a food; a curtain shielding at least one sidewall of the cavity; and a fixing portion fixing the curtain to the cavity.

In another embodiment, a curtain device of an oven includes: a rack seated in a cavity; a curtain hung on and supported by the rack; and a cut portion in the curtain to avoid interference with an inner structure of the cavity.

In further another embodiment, a method of using an oven includes: installing a curtain to an inner surface of a cavity in the oven before cooking, the curtain shielding the inner surface to prevent exposure of the inner surface; and removing the curtain after the cooking.

### ADVANTAGEOUS EFFECTS

According to the aforementioned embodiments, the oven is used under more clean conditions, and the cooked conditions of a food in the oven can be more sanitary and clean. Also, the oven cavity is inherently prevented from being contaminated, thereby removing problems relating to contamination.

### BRIEF DESCRIPTION OF THE DRAWINGS

FIG. 1 is a perspective view illustrating an oven according to an embodiment.

FIG. 2 is a cross-sectional view taken along a line I-I of FIG. 1.

FIG. 3 is a cross-sectional view taken along a line II-II of FIG. 1.

FIG. 4 is a cross-sectional view illustrating a rack according to an embodiment.

FIG. 5 is a cross-sectional view illustrating a rack according to another embodiment.

FIG. 6 is a perspective view illustrating an oven according to another embodiment.

### MODE FOR THE INVENTION

Reference will now be made in detail to the embodiments of the present disclosure, examples of which are illustrated in the accompanying drawings.

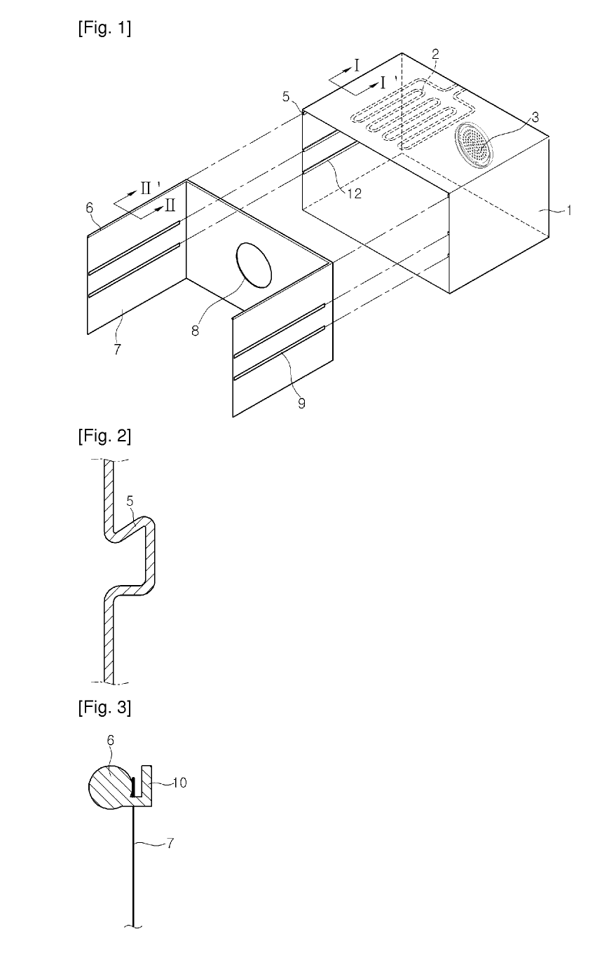

FIG. 1 is an exploded perspective view illustrating an inner structure of an electric oven according to an embodiment.

### Embodiment

FIG. 1 is the perspective view illustrating the oven according to the embodiment.

Referring to FIG. 1, the oven includes a cavity 1 selectively closed against the outside. The cavity 1 includes a grill heater 2 and a convection heater 3. The grill heater 2 is adapted to heat an inner space of the cavity 1 to a high temperature with radiation. The convection heater 3 is adapted to heat a food in the inner space of the cavity 1 with hot air.

Meanwhile, side surfaces and a rear surface of the cavity 1 are susceptible to severe contamination and difficult to clean.

In the case of a top surface of the cavity 1, since the grill heater 2 installed on the top surface burns out contamination, the contaminants cannot adhere to the top surface.

Also, a bottom surface of the cavity 1 is shielded by a food tray to prevent the adherence of contaminants. Thus, among inner surfaces of the cavity, the side surfaces and the rear surface are especially susceptible to the adherence of contaminants.

For these reasons, when the oven according to this embodiment operates, a curtain shields the side surfaces and the rear surface of the oven.

Then, contaminants generated in the cavity 1 during cooking, for example, splashed oil during heating a food is absorbed into the curtain to prevent the oil from reaching the side surfaces of the cavity 1.

Also, since splashed oil or burned remainders generated during cooking do not fall to a food, the cooked conditions of the food are more hygienic.

Furthermore, smoke generated during cooking also adheres to the curtain without adhering to the inner surfaces of the cavity 1. Therefore, the cooked conditions of the food are better, and there is no use cleaning the inner surfaces of the cavity 1.

The curtain is supported by the inner surfaces of the cavity 1. Hereinafter, a curtain device will now be described in detail.

Rack holders 5 are provided to the sidewalls of the cavity 1. The rack holders 5 are longitudinally disposed in a back and forth direction and formed in the manner where the sidewalls of the cavity 1 partially protrude a predetermined length. In addition, an end of a protrusion in the rack holder 5 may rise upward to a predetermined height.

FIG. 2, which is a view taken along a line I-I′ of FIG. 1, clearly illustrates a cross-section of the rack holders 5.

Although the rack holders 5 are continuously disposed in a back and forth direction, the rack holders 5 may be intermittently disposed on the sidewalls of the cavity 1. Thus, the rack holders 5 may have any shape provided only that a rack 6 is hung on the rack holders 5.

However, since a front portion of the rack 6 is opened toward an oven door, the rack 6 is susceptible to deformation. Thus, given this limitation, the rack holders 5 may be bent upward such that the rack 6 is firmly supported against even air movement.

The rack holders 5 support the curtain device according to the embodiment. The curtain device includes the rack 6 seated on the rack holder 5, and the curtain hung on the rack 6 and extended downward.

The rack 6 is provided to three surfaces along the sidewalls and the rear surfaces such that the curtain extends along the rear surface or the sidewall. Then, the curtain 7 is entirely hung down from the rack 6.

As such, the curtain 7 is formed to shield the sidewalls and the rear surface of the cavity 1. In this case, the curtain 7 may interfere with the inner structure of the oven.

To avoid this interference, side portions of the curtain 7 include groove-facing cut portions 9 to prevent the curtain 7 from being raised by grooves 12 provided to the sidewalls of the cavity 1. The grooves 12 are indentations used to seat the tray.

Also, a heater-facing cut portion 8 is formed in a position corresponding to the convection heater 3 in the rear surface of the curtain 7. Air discharged from the convection heater 3 passes through the heater-facing cut portion 8, thereby preventing pulsation of the curtain 7 due to air discharged from the convection heater 3.

That is, the curtain 7 may include the plurality of cut portions including the first cut portion 8 and the second cut portions 9.

Here, the cut portions 8 and 9 may be spaced cut holes that are pre-processed according to shapes defined at the curtain 7.

Meanwhile, an oil paper may be used as the curtain 7, which is not burned at a high temperature and has excellent absorption.

Such an oil paper is commonly referred to as a paper foil, and also referred to as a parchment paper or a weighing paper. The oil paper absorbs oil well to prevent dropping of the oil. Also the oil paper has a high ignition point, it is adapted to be used in an oven.

Since the oil paper is resistant to folding, the oil paper keep its original position even when there is some air movement in the cavity 1.

Meanwhile, the curtain 7 may include a reinforcing member to prevent the curtain 7 hung on the sidewall of the cavity 1 to be moved by discharged air. The reinforcing member may be provided to an edge or an upper portion and a lower portion of the curtain 7. That is, the reinforcing member may serve as a frame of the curtain 7.

Also, the reinforcing member may be attached to one side of the curtain 7 through glue, and include a wire as a material but the material is not limited thereto provided only that the reinforcing member prevents the movement of the curtain 7.

Also, the curtain 7 may be replaceable, i.e., be disposable. Alternatively, the curtain 7 may include a waterproof fabric instead of the oil paper.

FIG. 3 is a cross-sectional view taken along a line II-II of FIG. 1.

Referring to FIG. 3, the rack 6 has a circular cross-section, and a protrusion 10 is provided on an inner side thereof. The curtain 7 is hung on and supported by the protrusion 10. To this end, the curtain 7 may include a through hole receiving the protrusion 10.

A method of using the oven according to this embodiment will now be described.

Firstly, before operating the oven, the curtain 7 is hung on the rack 6 to form the curtain device. The curtain 7 is hung down, and the protrusion 10 is inserted into the through hole in the upper portion of the curtain 7.

That is, the position of the curtain 7 is fixed by the protrusion 10 inserted into the through hole.

Meanwhile, before hanging the curtain 7, the cut portions 8 and 9 may be cut in the curtain 7 according to the type of an oven.

Thereafter, the rack 6 is inserted into the cavity 1 to hang the rack 6 on the rack holders 5. When the rack holders 5 support the rack 6, the grooves 12 of the cavity 1 and the convection heater 3 are exposed to the outside, so that the operation of the oven is not affected.

Then, the tray including a food is installed into the cavity 1. It will be easily appreciated that the tray is seated on the grooves 12. Then, when the oven is operated, oil remainders and smoke generated during cooking the food are absorbed into the curtain 7, but not adhered to the walls of the cavity 1.

Particularly, the smoke and oil remainders generated during cooking are easily absorbed into an oil paper used as the curtain 7, thereby improving convenience.

When the cooking is finished, the curtain device is detached, and the disposable curtain 7 is removed from the rack 6.

As a matter of course, although the oil paper may be continuously used through repeated cooking with oven, it is desirable to limit its use period considering the decay of the paper due to long use.

### Another Embodiment

Another embodiment is the same as the preceding embodiment except for a manner in which the curtain 7 is hung on the rack 6. Thus, the same part as the description of the preceding embodiment will be omitted.

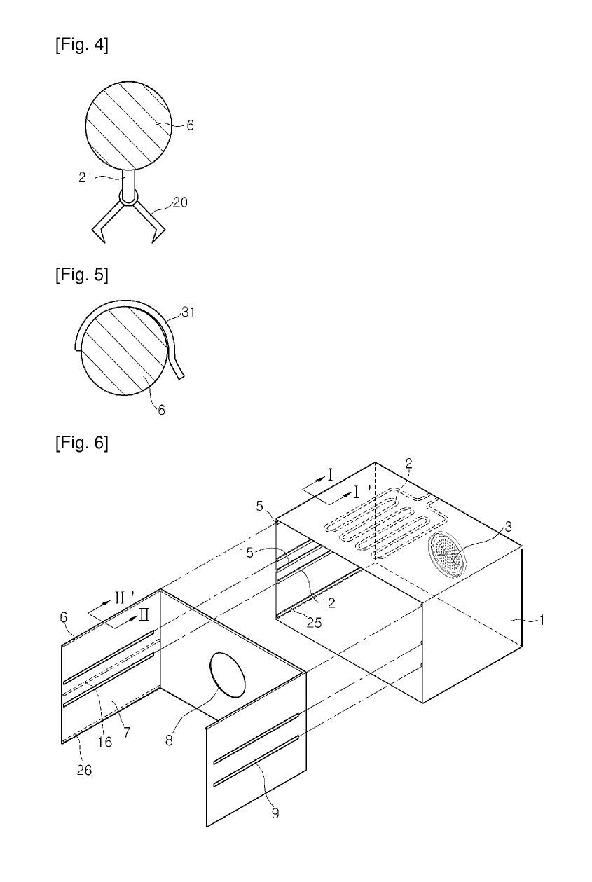

FIG. 4 is a cross-sectional view illustrating a rack 6 according to this embodiment.

Referring to FIG. 4, an extension 21 is provided to the rack 6, and tongs 20 are provided to an end of the extension 21. The tongs 20 may hold the curtain 7.

In addition, the extension 21 extends from the rack 6. The extension 21 may extend in one direction from the rack 6. That is, the extension 21 may extend downward or laterally.

According to this embodiment, a user can more conveniently install the curtain.

### Further Another Embodiment

Further another embodiment is the same as the preceding embodiments except for a manner in which the curtain 7 is hung on the rack 6. Thus, the same part as the description of the preceding embodiments will be omitted.

FIG. 5 is a cross-sectional view illustrating a rack 6 according to this embodiment.

Referring to FIG. 5, a spring 31 is further provided to a surface of the rack 6. The spring 31 may extend on an outer circumference surface of the rack 6.

In addition, an inlet of the spring 31 may expand.

Through the expanding inlet of the spring 31, the curtain 7 may be inserted between the rack 6 and the spring 31. Especially, a member having a predetermined stiffness such as an oil paper is more effectively inserted.

It will be appreciated that the curtain 7 deeply inserted into the spring 31 is easily fixed to its position by a pressing operation of the spring 31.

According to this embodiment, the curtain 7 can be conveniently inserted into a gap between the spring 31 and the rack 6.

Although the rack is hung on the curtain according to the aforementioned embodiments, a curtain may be directly supported by a cavity. For example, the protrusion 10, the tongs 20, or the spring 31 may be directly provided to a cavity.

### Still Further Another Embodiment

Still further another embodiment is the same as the preceding embodiments except for the rack 6 and the rack holders 5. Thus, the same part as the description of the preceding embodiments will be omitted.

FIG. 6 is a perspective view illustrating an oven according to this embodiment.

A plurality of rack holders 5, 15 and 25 may be provided to the sidewalls of the cavity 1.

Particularly, the cavity 1 includes the upper rack holders 5 in an upper portion, the middle rack holders 15 in a middle portion, and the lower rack holders 25 in a lower portion. The rack holders 15 and 25 have the same configuration as that of the rack holders 5.

Also, the curtain 7 may include the upper rack 6, a middle rack 16, and a lower rack 26 that are respectively disposed at corresponding positions to the rack holders 5, 15 and 25. The racks 6, 16 and 26 may be hung on the rack holders 5, 15 and 25, respectively.

Although the plurality of rack holders 5, 15 and 25 are illustrated in FIG. 6, only the upper rack holders 5 and the middle rack holders 15 may be provided, or only the upper rack holders 5 and the lower rack holders 25 may be provided.

As described above, the plurality of racks 6, 16 and 26 are hung on the rack holders 5, 15 and 25, so that the curtain 7 can be easily fixed to the sidewalls of the cavity 1. Thus, oil remainders or smoke in the cavity 1 are more effectively absorbed to the curtain 7.

According to the aforementioned embodiments, the curtain is fixed. Thus, the parts fixing the curtain may be referred to as a fixing portion.

Hereinafter, other embodiments than the aforementioned embodiments will now be described.

As described above, the curtain is also provided to the rear surface of the cavity.

However, since oil remainders adhering to the rear surface of the cavity are sufficiently burned out by heat generated from the convection heater, a curtain may be hung on only the side surfaces of the cavity.

Furthermore, in the case where a food leans on one side, that is, contaminants are concentrated on the side of the cavity, a curtain may be installed to only the corresponding one among the side surfaces of the cavity.

Also, considering there are various ovens, a plurality of cut portions are prepared according to a type of oven, and only a relevant cut portion may be cut out.

Also, since the front portion of the rack is opened toward the oven door, a side portion of the rack may be easily modified.

Particularly, a front end of the side portion may be deformed without any interference. In this case, the rack may be detached from the rack holder without being hung on the rack holder.

To address this limitation, the rack may have a rectangular shape. Thus, the rack maintains its original shape and minimizes deformation.

Although the front portion of the rack is opened, since an end of the rack holders extends a predetermined length, the rack holders are not affected to support the rack.

Also, although the oil paper is exemplified as the material of the curtain, an aluminum foil may be used as the material of the curtain. That is, the curtain may be formed of any material provided only that a sheet covers the inner surfaces of the cavity.

In the case of an oven with microwaves, since a metal sheet is inappropriate to be used, an oil paper may be used. Furthermore, the oil paper is adapted to absorb oil.

According to the preceding embodiment, the rack has approximately an angular U shape. That is, the rack has bent three portions to cover the both side surfaces and the rear surface of the oven.

However, the rack is not limited to this single structure, and thus three respective portions may be separated from each other.

In other words, a rack may be independently provided and supported by only one side surface of the cavity, or such a rack may be installed to each side surfaces of the cavity.

Meanwhile, the entire rack is installed with one loading movement, so that a user more conveniently loads the racks.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

According to the aforementioned embodiments, the oven is used under more clean conditions, and the cooked conditions of a food in the oven can be more sanitary and clean. Also, the oven cavity is inherently prevented from being contaminated, thereby removing problems relating to contamination.

1. An oven comprising:
a cavity receiving and heating a food;
a replaceable curtain shielding at least one sidewall of the cavity; and
a fixing portion fixing the curtain to the cavity.

2. The oven according to claim 1, further comprising:
a rack holder to the sidewall of the cavity; and
a rack supported by the rack holder.

3. The oven according to claim 2, wherein the curtain is supported by the rack.

4. The oven according to claim 2, wherein the curtain extends downward from the rack.

5. The oven according to claim 1, wherein the fixing portion is provided to an upper portion and a lower portion of the cavity.

6. The oven according to claim 1, wherein the fixing portion is provided to an upper portion and a middle portion of the cavity.

7. The oven according to claim 1, wherein the fixing portion comprises a protrusion on which the curtain is hung.

8. The oven according to claim 1, wherein the fixing portion comprises tongs holding the curtain.

9. The oven according to claim 1, wherein the fixing portion comprises a spring pressing and fixing the curtain.

10. The oven according to claim 1, wherein the cavity comprises a convection heater discharging hot air, and
the curtain comprises a first cut portion at a position corresponding to the convection heater.

11. The oven according to claim 1, wherein the cavity comprises a groove on which a tray is seated, and
the curtain comprises a second cut portion at a position corresponding to the groove.

12. The oven according to claim 1, wherein the curtain comprises an oil paper.

13. The oven according to claim 1, wherein the curtain comprises a reinforcing member for preventing movement of the curtain.

14. A curtain device of an oven, the curtain device comprising:
a rack seated in a cavity;
a curtain hung on and supported by the rack; and
a cut portion in the curtain to avoid interference with an inner structure of the cavity.

15. The curtain device according to claim 14, wherein the cut portion comprises, a groove-facing cut portion preventing the curtain from being raised by a groove provided to a side surface of the cavity.

16. The curtain device according to claim 14, wherein the cut portion comprises, a heater-facing cut portion, and air discharged into the cavity by a heater passes through the heater-facing cut portion.

17. The curtain device according to claim 14, wherein the cut portion comprises a cut hole.

18. The curtain device according to claim 14, wherein the rack is provided to a side surface and a rear surface of the cavity, and the curtain extends along the rack.

19. The curtain device according to claim 14, wherein the rack comprises a protrusion on which the curtain is hung.

20. The curtain device according to claim 14, wherein the curtain comprises an oil paper.

21. A method of using an oven, the method comprising:
installing a curtain to an inner surface of a cavity in the oven before cooking, the curtain shielding the inner surface to prevent exposure of the inner surface; and
removing the curtain after the cooking.

22. The method according to claim 21, wherein in the installing of the curtain, the curtain shields a side surface and a rear surface of the cavity.

23. The method according to claim 21, wherein the curtain comprises an oil paper.
